(19) United States
(12) Patent Application Publication
(10) Pub. No.: US 2013/0083215 A1
(43) Pub. Date: Apr. 4, 2013

(54) Image and/or Video Processing Systems and Methods

(71) Applicant: Netomat, Inc., New York, NY (US)

(72) Inventor: Maciej Wisniewski, New York, NY (US)

(73) Assignee: Netomat, Inc., New York, NY (US)

(21) Appl. No.: 13/633,506

(22) Filed: Oct. 2, 2012

Related U.S. Application Data
(60) Provisional application No. 61/542,664, filed on Oct. 3, 2011.

(51) Int. Cl. H04N 5/228

(52) U.S. Cl. 348/222.1; 348/E05.031

(57) ABSTRACT

A system, a method, and a computer-program product for image and/or video processing are disclosed. A template to be used in conjunction with a content to be captured by an optical device is provided. The optical device includes a viewfinder mechanism. The content is captured using the optical device. The captured content and the template in the viewfinder mechanism of the optical device are combined. A final content containing the captured content and the template is generated.

### CROSS-REFERENCE TO RELATED APPLICATIONS

The present application claims priority to U.S. Provisional Patent Application Ser. No. 61/542,664, filed on Oct. 3, 2011, which relates to U.S. patent application Ser. No. 12/644,765, filed on Dec. 22, 2009, which claims priority to U.S. Provisional Patent Application Ser. No. 61/140,569, filed on Dec. 23, 2008, the disclosures of which are incorporated herein by reference in their entireties.

### TECHNICAL FIELD

The subject matter described herein relates to image processing and in particular, to image and/or video content manipulations.

### BACKGROUND

Captured video and/or image editing is a process of editing videos and/or images by adding various special effects, sound recordings, altering quality of images, addition of other objects and performing various other manipulations in the post-capture process. Technology today can allow for such editing through use of various applications, software, hardware, devices, etc. It is common for users (and especially, professional users) to edit captured images/videos to improve quality of the captured content so that the end results may be more appealing to the end user of the captured content.

However, conventional systems do not allow manipulation of content about to be captured on a viewfinder through use of overlays, templates, other content, imagery, animations, annotations, etc. on the viewfinder itself. Thus, there is a need for a system and a method that can allow a user of an optical device to implement a content manipulation mechanism that can enhance, alter, and/or otherwise manipulate content being viewed in a viewfinder of the optical device that will be used to capture the viewed content. Further, there is a need for a system and a method that can implement templates that can be used in connection with a viewfinder mechanism for manipulating, altering, enhancing, etc. content about to be captured. In some embodiments, there can be significant benefit to a user who intends to add additional layers on top of an image and/or a video to be captured such as borders, frames, captions, annotations, animations, text, other images, and/or even another video, and/or any combination thereof to be able to see those additional layers in a viewfinder of the device while the user is capturing the image and/or video so as to ensure that the captured content is positioned exactly the way the user wants it to be positioned within the context of those layers. This concept can be referred to as WYSIWYG (“What-You-See-Is-What-You-Get”) recording. Once captured, the same layers and captured content can be also presented on the screen using the device's preview capability for subsequent additional manipulation. For users, WYSIWYG recording and preview capabilities can be configured to save a significant post-production effort.

### SUMMARY

In some embodiments, the current subject matter relates to a computer-implemented method for generating content. The method includes providing a template to be used in conjunction with a content to be captured by an optical device, wherein the optical device includes a viewfinder mechanism, capturing the content using the optical device, combining the captured content and the template in the viewfinder mechanism of the optical device, and generating a final content containing the captured content and the template.

In some embodiments, the current subject matter can be configured to include one or more of the following optional features. The template can include a static image, a video, an animation, a user-editable content, and any combination thereof. The template can be a digital template. The template can be a physical template configured to be attached to the viewfinder mechanism of the optical device. The generating can include previewing at least one of the captured content, the template, and a combination of the captured content and the template using the optical device. The generating can also include editing at least one of the captured content, the template, and a combination of the captured content and the template using the optical device. The generating can further include processing at least one of the captured content, the template, and a combination of the captured content and the template using a remote computer.

Articles are also described that comprise a tangibly embodied machine-readable medium embodying instructions that, when performed, cause one or more machines (e.g., computers, etc.) to result in operations described herein. Similarly, computer systems are also described that can include a processor and a memory coupled to the processor. The memory can include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

Articles are also described that comprise a tangibly embodied machine-readable medium embodying instructions that, when performed, cause one or more machines (e.g., computers, etc.) to result in operations described herein. Similarly, computer systems are also described that can include a processor and a memory coupled to the processor. The memory can include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

FIG. 1 illustrates an exemplary capturing of content and overlaying a template, according to some embodiments of the current subject matter.

FIG. 2 illustrates an exemplary content preview capability, according to some embodiments of the current subject matter.

FIG. 3 illustrates an exemplary physical template used in conjunction with an optical device, according to some embodiments of the current subject matter.

FIG. 4 illustrates an exemplary editing of a captured content, according to some embodiments of the current subject matter.

FIG. 5 illustrates an exemplary content recording, previewing and creating, according to some embodiments of the current subject matter.

FIG. 6 illustrates an exemplary content editing, according to some embodiments of the current subject matter.

FIG. 7 illustrates an exemplary use of a physical template, according to some embodiments of the current subject matter.

FIG. 8 illustrates exemplary physical templates, according to some embodiments of the current subject matter.

FIG. 9 illustrates exemplary template with overlay content selected by a user and presented inside a photo/video camera viewfinder or a preview window, according to some embodiments of the current subject matter.

### DETAILED DESCRIPTION

Some embodiments of the current subject matter relate to image and/or video image creation and processing and in particular, to creation of various image/video objects that can be used in conjunction with the created image/video for further processing. In some embodiments, image and/or video processing can be configured to refer to image processing, video processing, image and video processing, image or video processing, and/or any combination thereof. Such processing can include processing of a still image, a moving image, a text, an animation, a video, an annotation, and/or any other object, and/or any combination thereof. The image/video objects can be created in a predetermined lightweight format. The image/video objects can be digital and/or physical templates that can be used with the image and/or video. In some embodiments, the image/video objects can be configured to be superimposed on viewfinder of an image/video capturing apparatus (e.g., a camera, a camcorder, a device having a camera/camcorder capability such as a smartphone, a PDA, an iPhone, an iPod, an iPad, a Palm device, a telescope, binoculars, oculars, and/or any other optical device that is capable of providing image/video viewing, capturing, creating, manipulating, processing, etc. capabilities, and/or any combination thereof (hereinafter, “optical device”)). In some embodiments, such image/video objects can also appear on the optical device's preview window, screen, or a separate monitor, screen, television screen, computer, screen, and/or any other viewing device, and/or any combination thereof, while previewing the image and/or video stream captured (whether or not such image was just captured or captured sometime in the past). In the following discussion, the above referenced image/video objects will be referred to as an “image template”, “video template”, “viewfinder template”, “preview template”, “template”, “overlay”, “overlay template”, and/or “format”. Such references are for illustrative purposes only and are not intended to limit the scope of the subject matter described herein. The following discussion will also illustrate the concepts described herein as used in a camera, but can be used in any camera, camcorder, device having a camera/camcorder capability such as a smartphone, a PDA, an iPhone, an iPod, an iPad, a Palm device, a telescope, binoculars, oculars, and/or any other optical device that is capable of providing image/video viewing, capturing, creating, manipulating, editing, processing, etc. capabilities, and/or any other optical device and/or any combination thereof.

Such templates can be useful for photographers, videographers, average consumers, professional photographers, professional videographers, and/or any other users. The current subject matter can be used by manufacturers of cameras (whether digital or non-digital), camcorders, camera phones, video and/or image creating, editing, and/or processing equipment, and/or any optical equipment. The current subject matter can be also used to capture still photographs or video and can be used by third party developers to create new applications that embed this technology into their own applications.

In some embodiments, the current subject can be configured to augment, alter, change, modify, edit, manipulate, process, etc. what a user would see through a device capable of capturing a still image, a device capable of capturing a live video, etc. and subsequently combine the captured image/video with the template to create a final image/video that matches what the user actually sees in the viewfinder.

In some embodiments, the current subject matter can be configured to create a template for use in an optical device. In some embodiments, such templates can be created by end-users using simple third party video editing and animation tools and/or photo-editing tools such as GIMP or Photoshop. Templates can be static (e.g., just a photo with a transparent area cut out), animated (e.g., combining still images, animations and video) and/or “real-time” (which means that it can include content retrieved from a content-feed at the time of template selection). Templates can also be created in real time using various software applications. In some embodiments, the templates can be physical templates as well as can be created using any available methods/systems.

In some embodiments, the source content required to generate such template can be created by a user using existing photo editing or video editing tools. The source content can then be uploaded to a server that can be configured to transform the source content into the template format. In some embodiments, the templates can be configured to include the following:

multiple content types—image, video, animations, audio, text, and/or any other content types;

dynamically loaded content (which can include any desired content, whether such content is created “on the fly”, uploaded from the Internet, from a local storage, a network, received in an email, and/or obtained in any other fashion);

special effects;

zooming capabilities;

Metadata, such as video template length, loop frequency, orientation (portrait/landscape), default camera to be used if more than one present on device, categories, tags, geo-location, author, creation date, etc.

In some embodiments, the current subject matter's templates can be configured to work with any optical device. The templates can be configured to have a “lightweight” format and can be configured to work well on various optical devices (e.g., mobile devices) that may have limited processing capabilities. In some exemplary embodiments, the template format is a PNG (“portable network graphics”) based animated image format with synchronized sound track supporting 24-bit images and 8-bit transparency and providing high-quality animation at lower frame rates. As can be understood, other template formats can be used and the current subject matter is not limited to this exemplary format.

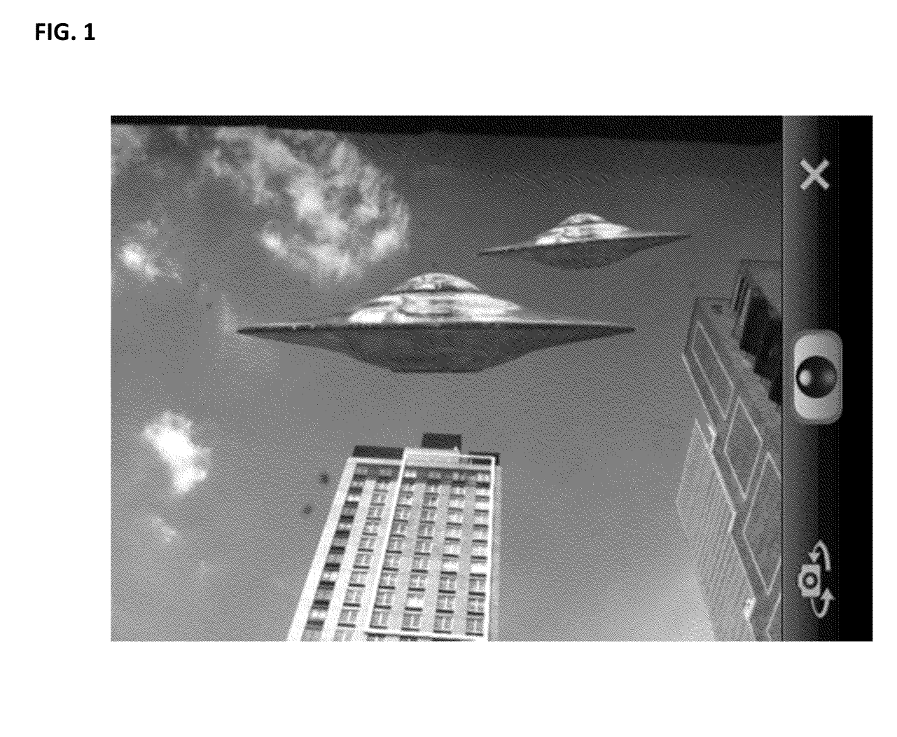

In some embodiments, the current subject matter can be configured to capture content and use a template to overlay the captured content. The user of a technology capturing a photo or video can choose to overlay a template on top of the camera viewfinder to position the object and/or content being captured within the context of the template in real time. FIG. 1 illustrates an exemplary capturing of the content and overlaying a template (e.g., “UFO”) on the captured content (e.g., “New York skyline”). In some embodiments, the user can select a “UFO” template and take a video of the New York skyline using that template. The user can position the skyline within the template such that the video being captured can appear to show live footage of New York City being attacked by UFOs, as shown in FIG. 1. The template can be selected from the optical device's memory and/or obtained from the Internet, server, external memory, received in an email, and/or obtained in any other fashion. In some embodiments, such templates can be also created on the fly. The template can be selected before content is captured, while content is being captured, and/or after the content has been captured. Further, the template can be changed at any of these times after one template has been selected. Also, more than one template can be used in connection with the content (e.g., a combination software-based templates and/or physical templates can be used).

By way of another example, the user can select a template that is a still image of a photo frame hanging on a wall with a transparency where the photo would be. The user can then position the object and/or content that s/he wishes to capture in the transparent area and then capture a video and/or a still image. The content being captured can be positioned perfectly or as desired within the photo frame template. For example, a family traveling to Paris creates a template with a thumbnail of the Eiffel Tower and a scrolling caption that reads “The Jones Family Vacation in Paris.” Each family member uses the template while taking pictures and videos so that each photo and each video will be personally “branded” with the above thumbnail and caption.

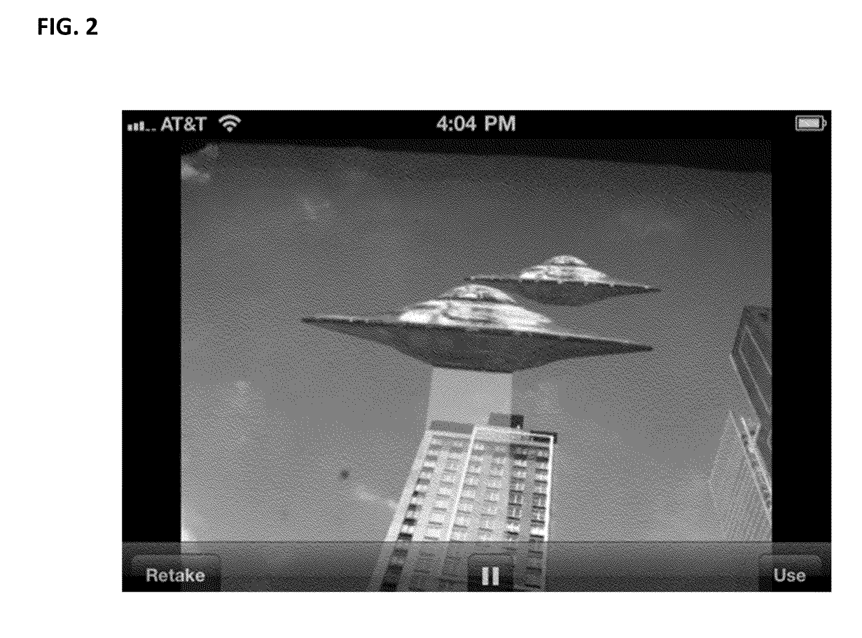

In some embodiments, the current subject matter can be configured to allow preview of the captured content. Once the content is captured, the template can be automatically layered onto a preview window of the optical device used to capture the content so that the user can see exactly what the user captured in the content of the template in real time. This can allow the user to decide whether to save the content, to discard and/or recapture the content and/or to edit the content, as discussed below. FIG. 2 illustrates such exemplary content preview capability, whereby a UFO template is superimposed on a New York City skyline in Preview/Playback mode.

In some embodiments, the current subject matter can be further configured to allow the user to create a final result based on the captured content and template(s) used. Once the user decides to use the content that the user captured, that content can be sent to a “processing engine” along with any relevant metadata that can be used for synchronizing the captured content with the selected template(s). In some embodiments, the processing engine can reside on a remote server, a personal computer, and/or any other device. In some embodiments, the processing engine can be configured to be disposed within the optical device configured to capture the content. Once the processing engine receives the content, it can combine the content and template layers together to create the final image/video (in some embodiments, still images with a template layer can be created based on the captured video content). The current subject matter can be further configured to separate the “what-you-see-is-what-you-get” (“WYSIWYG”) based capturing and previewing functions from the processing functions to enable flexibility and various capabilities as discussed below.

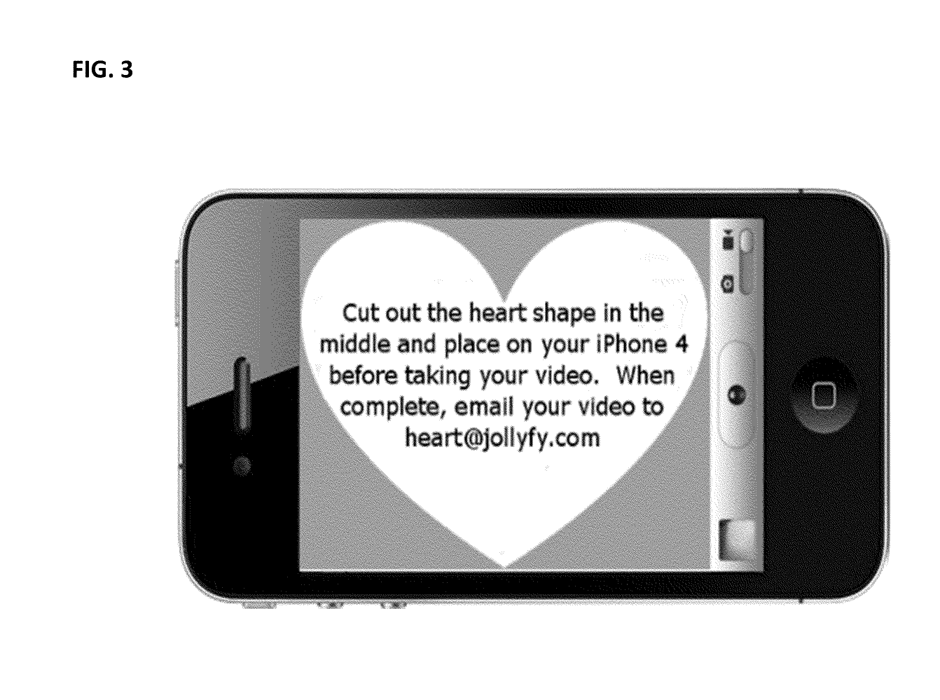

Such separate processing can enable deployment of the video template functionality on low end devices that may not have the processing capabilities required to combine the content and template layers and create various output formats for subsequent viewing/playback across myriad devices. It can also enable deployment of physical templates as opposed to software-based templates to accomplish similar results. For example, a camera manufacturer can distribute or sell physical cardboard, plastic cutouts, and/or any other physical templates that can be placed on a digital camera or video camera's viewfinder so that the end user can frame the content they are capturing within the context of the cutout template. The user then uploads the photo or video they captured to a server along with a unique identifier assigned to the cutout. The server then applies a corresponding video template over the user's content to create the final result. In other examples, a consumer brand can allow users to download from the web and print cutout templates that are explicitly sized to fit on the screen of various mobile phone models such as a smartphone, a PDA, an iPhone, an iPod, an iPad, a Palm device, a telescope, binoculars, oculars, and/or any other optical device that is capable of providing image/video viewing, capturing, creating, manipulating, processing, etc. capabilities, and/or any combination thereof. The user can be instructed to place the cutout on the viewfinder of the camera phone while the picture or video is being captured so that they can position themselves or their subject correctly in the cutout areas. The user can then be instructed to email the photo or video to a predetermined email address that the server can associate with a specific software video template that corresponds to the cutout and then process the user's content accordingly and deliver it back to the user for viewing and sharing, as illustrated in FIG. 3.

In some embodiments, the sizes of templates (whether physical or software-based) can be configured to be adaptable and/or adjustable to different viewfinders of different optical devices. In some embodiments, the sizes of templates can be adjusted locally on a particular optical device and/or can be adjusted remotely during processing of the captured content. Further, the user, while capturing and/or previewing the content, can also adjust/adapt a particular template to the optical device's viewfinder as desired, or the template can be adapted/adjusted automatically with which the template is being used.

In some embodiments, the templates (whether physical and/or software-based) can be configured to include moving parts, animations, color changing schemes, embedded objects, and/or any other desired features. In some embodiments, the user can add such features are added to a template selected by the user that otherwise appears static. Such feature can also be added to the template during processing of the captured content.

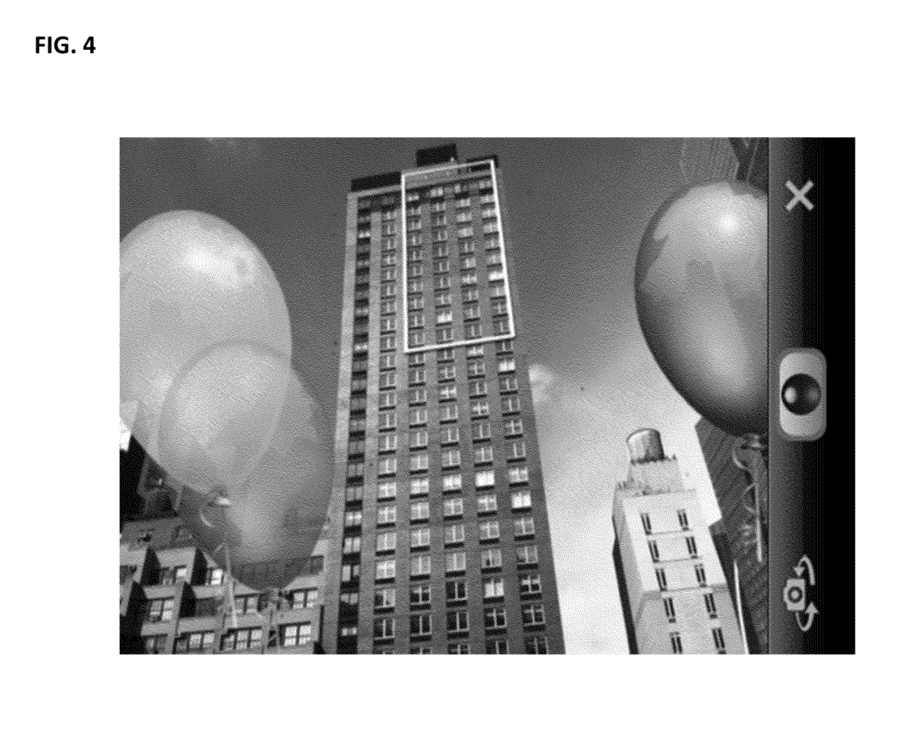

In some embodiments, the current subject matter can be configured to allow for editing of the captured content. In some embodiments, the use of the template can be configured to allow for immediate WYSIWYG editing. Since the template and the underlying content being captured can be configured to be discrete layers, each layer can be separately manipulated within the context of the other layer. For example, the animation in the template layer can be easily sped up, slowed down, resized, color-adjusted, etc. to accommodate the content being captured by the user or to enable a specific effect the user wishes to create. Similarly, the content being captured can also be sped up, slowed, down, zoomed in, zoomed out, resized, color-adjusted, etc. to suit the needs of the user for a given template. In some embodiments, the editing of the captured content can include addition of other objects (whether or not by way of templates or other captured content) as well as deletion, substitution, manipulation, etc. of objects in the captured content. As can be understood, the editing tools described above are for illustration purposes only and are not meant to limit the breadth of editing tools that can be presented to the user in the context of the viewfinder and/or preview window. FIG. 4 illustrates exemplary editing of a captured image using an “Editing tool box” feature that can be configured to providing various editing capability. In some embodiments, the template can be edited independently of underlying video being captured (which can be referred to as “Discrete Assets on Timeline” tool). Another tool “Putting a movie-based filter” can be placed on top of a lens of the optical device and allow editing of the image as desired to suit the underlying content being captured. Further, the editing can be performed inside the viewfinder of the optical device. It can also be performed on the preview window and/or any other fashion.

In some embodiments, offering content creators an ability to capture and edit content in the WYSIWYG context of a template can lead to a reduction in “post-production” effort and costs that are currently incurred by editing and layering content on top of video and photos in conventional systems. This benefit can have applicability to an average consumer who wants to ensure that their photo/video is appropriately framed to fit into a holiday greeting card/movie frame, etc. that does not cut off one family member's head as well as to a sophisticated cinematographer making a movie with green-screen effects and ensuring the actors and action are positioned appropriately for a scene or scenes to be added in later.

In some embodiments, video can be shared with devices that have various software processing applications that can be installed and then played back inside such applications without requiring server-side processing. The current subject matter can leverage meta-information that can be sent along with the captured video.

Further, in some embodiments, a zoom feature can be implemented along with the template. The zooming of the template, captured content, and/or a combination of both can be performed directly on the optical device configured to capture the content. Alternatively, such zooming can be performed on the server receiving the captured content. The zoom effect can be also faked by image masking on the optical device for preview. Meta data can be sent to the server and then captured content can be cropped to match the dimensions sent in the metadata and to fit the template. In some embodiments, video format can include time-based assets that can be taken apart and reassembled, as disclosed in U.S. patent application Ser. No. 12/644,765, co-pending and co-owned, disclosure of which is incorporated herein by reference in its entirety.

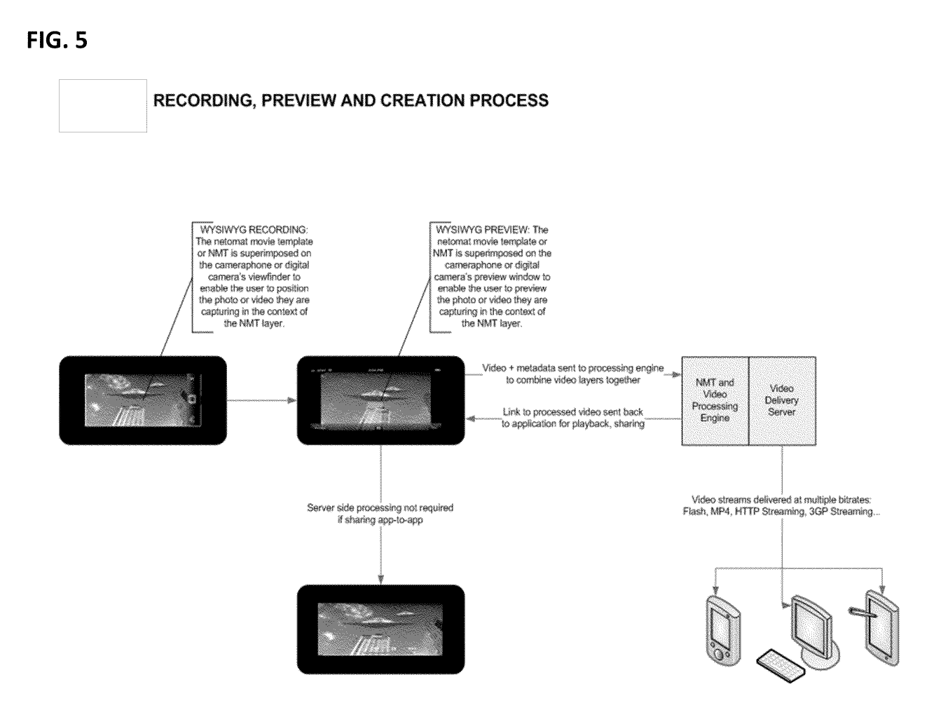

FIGS. 5-7 illustrate an exemplary content capturing, editing, and generation using a template, according to some implementations of the current subject matter. In case of a digital template, a user can install and launch an appropriate software application the optical device configured to capture content. Application can open the camera viewfinder and loads the template in the viewfinder, as shown in FIG. 5. Depending on “template orientation” (templates can be designed for portrait, landscape, or any other orientation recording), the recording button can be enabled for the user to begin recording video. For example, if user selected a “landscape template” but is holding the phone in portrait mode, the recording button can be disabled. When the user rotates device into landscape mode, the recording button can be enabled and the user can begin recording. In some embodiments, the optical device can capture content regardless of the orientation of the device and/or its viewfinder. The device can be configured to automatically adjust to a particular orientation. The user can also select a particular orientation and the device can be configured to adjust such orientation accordingly.

Then, the user captures content (e.g., captures a video, as shown in FIG. 5) with the template content overlaying portions of the view screen. Once the user is finished recording, the user can preview the recorded content with the template layer. The user can then choose to discard the captured video and start over or can choose to “use” the captured content.

If the user clicks “Use” then the application begins uploading the captured content to a server for processing. Once uploaded, the server can combine the captured content layers into one content stream and then output multiple content files for playback on any desired device (e.g., on the Internet, mobile device, and/or any other device). The user can then view a final captured content inside the application (e.g., it can be streamed from the server). The user can also share that content with anyone, as desired, such as via email or social media services such as Facebook.

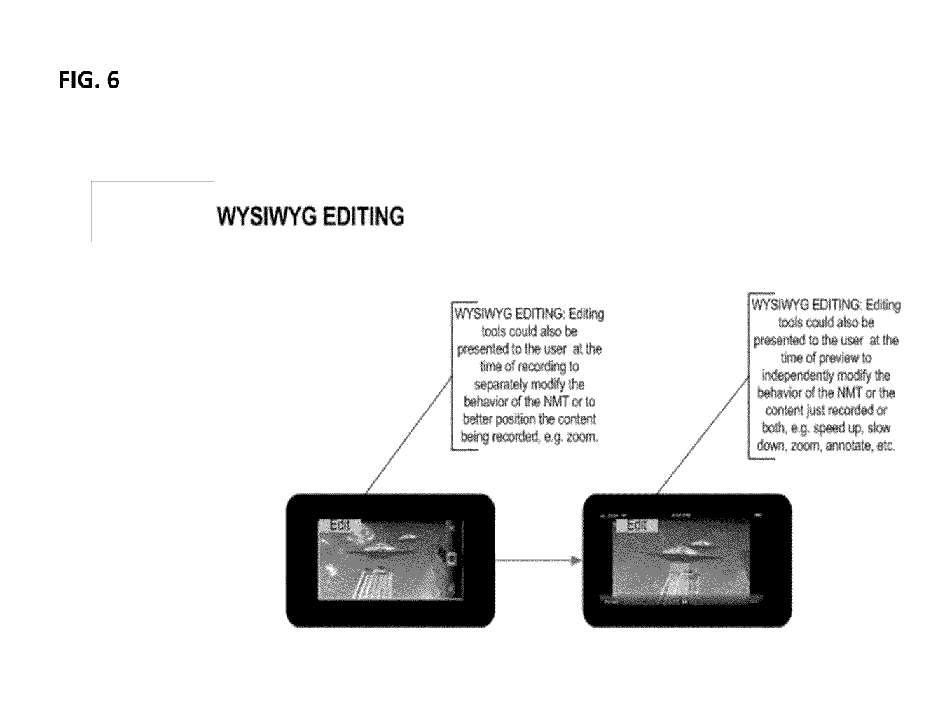

As shown in FIG. 6, the user can also choose to edit the captured content using various editing tools that can be available on the user's optical device. The tools can be presented to the user at the time of recording to modify the behavior of the template or to better position the content being recorded (e.g., zoom, crop, hue, color, contrast, etc.). In some embodiments, the editing tools can be presented to the user during preview of the recorded content to allow the user to independently modify the behavior of the template or the recorded content (e.g., zoom, speed-up, slow-down, zoom, crop, hue, color, contrast, annotate, etc.).

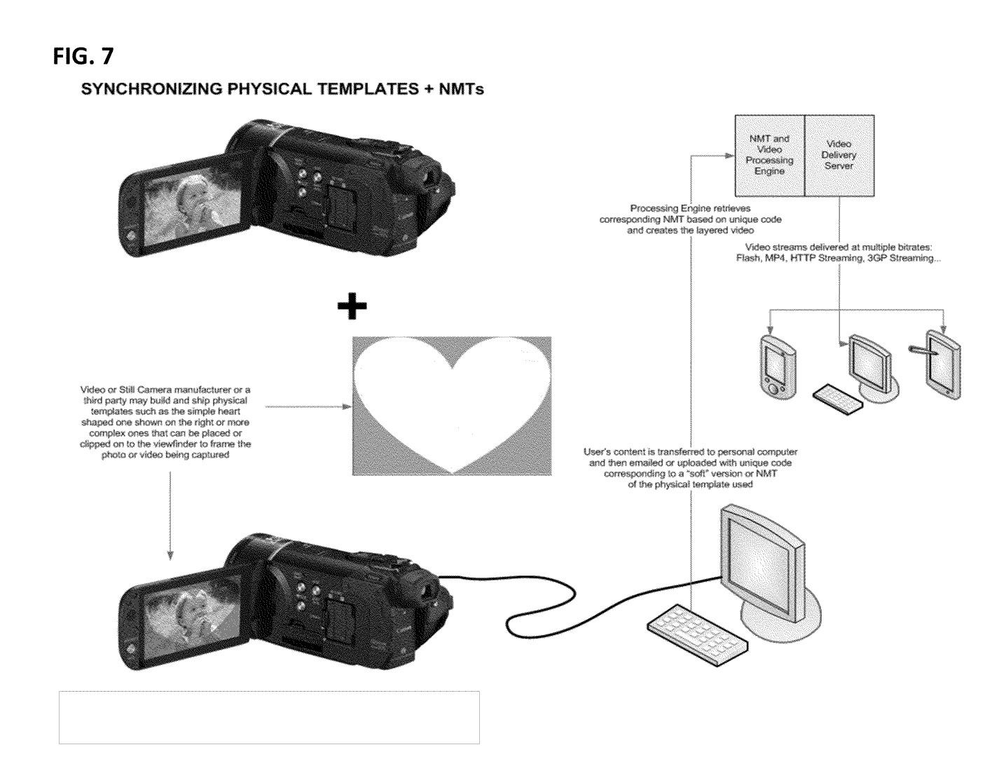

FIG. 7 illustrates use of physical templates (FIG. 7 shows a heart-shaped physical template that can be used in connection a camcorder), according to some implementations of the current subject matter. The user can select a particular physical template that is to be used together with the captured content and either use it when capturing content and provide it (e.g., by way of a particular number designating the template) to the server during processing. The user then captures content in view of the selected template. The selected template can be attached directly to the viewfinder while the content is being captured. Once the content is captured, it along with an identifier identifying the selected template is forwarded to the server for processing. The server uses the provided identifier obtains the selected template format from a database and overlays it on the captured content to create final captured content for preview by the user.

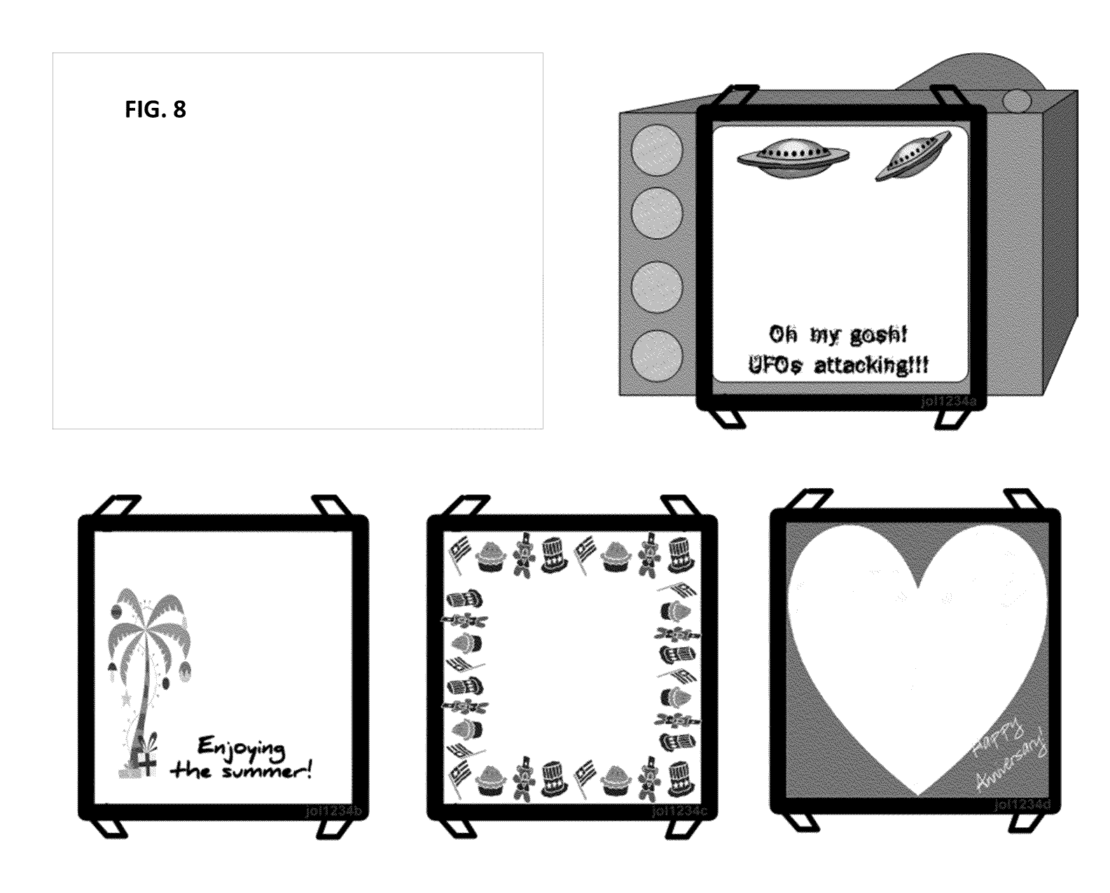

FIG. 8 illustrates exemplary physical templates and their uses, according to some embodiments of the current subject matter. Physical snap-on templates can be created and used with viewfinders of different sizes, shapes, and/or orientations. Such template can have an overlay content that can be configured to cover portion of the viewfinder screen so that the user capturing content can position the content being captured exactly the way the user wants the content in relation to the overlay content in the template. The template can have a unique identifier (e.g., “jol1234a”) that can identify this template for subsequent processing of captured content. The user can electronically submit the captured content for processing along with the unique template code/identifier so that the processing engine can apply the correct overlay template to the user's captured content.

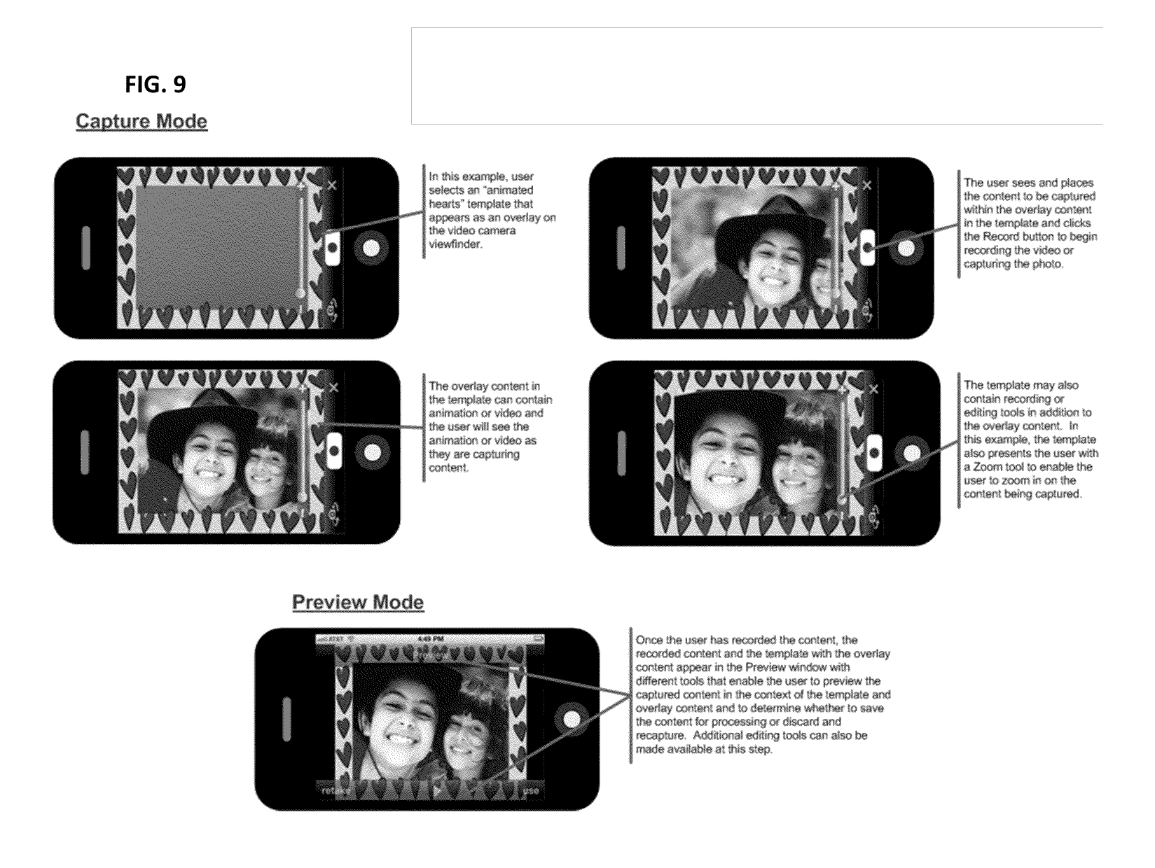

FIG. 9 illustrates exemplary template with overlay content selected by a user and presented inside a photo/video camera viewfinder or a preview window, according to some embodiments of the current subject matter. During the content capture mode, the user can select a particular template, such as an “animated heart” template, which can appear as an overlay on the optical device used to capture content. The overlay content in the template can contain animation, video, static images, etc. and the user can see the animation, video, static images, etc. as the user is capturing the content. The user can observe and place the content to be captured within the overlay content in the template and click a recording button to begin recording/capturing content (or initiate any other action to capture content). The template can also contain recording and/or editing tools in addition to the overlay content. For example, the template can include a zoom tool that can enable zooming in on the captured content. In the preview mode, once the user has recorded the content, the recorded content and the template with the overlay content can appear in the preview window of the optical device along any tools that can enable the user to preview the captured content and determine whether or not to save the content for processing or discard and recapture. Further content editing tools can also be provided to the user.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
providing a template to be used in conjunction with a content to be captured by an optical device, wherein the optical device includes a viewfinder mechanism;
capturing the content using the optical device;
combining the captured content and the template in the viewfinder mechanism of the optical device;
generating a final content containing the captured content and the template.

2. The method according to claim 1, wherein the template includes a static image, a video, an animation, a user-editable content, and any combination thereof.

3. The method according to claim 1, wherein the template is a digital template.

4. The method according to claim 1, wherein the template is a physical template configured to be attached to the viewfinder mechanism of the optical device.

5. The method according to claim 1, wherein the generating further comprises
previewing at least one of the captured content, the template, and a combination of the captured content and the template using the optical device.

6. The method according to claim 1, wherein the generating further comprises
editing at least one of the captured content, the template, and a combination of the captured content and the template using the optical device.

7. The method according to claim 1, wherein the generating further comprises
processing at least one of the captured content, the template, and a combination of the captured content and the template using a remote computer.
